(19) United States
(12) Patent Application Publication
(10) Pub. No.: US 2024/0271950 A1
(43) Pub. Date: Aug. 15, 2024

(54) NAVIGATION SYSTEM, ROUTE DETERMINATION DEVICE, NETWORK CONTROLLER, AND NAVIGATION METHOD

(71) Applicant: RAKUTEN MOBILE, INC., Tokyo (JP)

(72) Inventors: Jin NAKAZATO, Tokyo (JP); Saki TANAKA, Tokyo (JP); Haruka HORIUCHI, Tokyo (JP)

(73) Assignee: RAKUTEN MOBILE, INC., Tokyo (JP)

(21) Appl. No.: 18/020,536

(22) PCT Filed: Dec. 28, 2021
(86) PCT No.: PCT/JP2021/048792

§ 371 Date: Feb. 9, 2023

(51) Int. Cl. G01C 21/34; H04W 24/08; H04W 88/08

(52) U.S. Cl. CPC G01C 21/3461; G01C 21/3415; H04W 24/08; H04W 88/08

(57) ABSTRACT

A navigation system, comprising: a route determination device that has a map information device that stores map information and a route information providing device that selects one or more route candidates based on information indicating a starting point and a goal point in the map information; and a network controller that acquires and stores operation information regarding a base station, wherein the network controller acquires the one or more route candidates from the route determination device and supplies, to the route determination device, operation information regarding each base station corresponding to each area on the one or more route candidates, and the route information providing device at least provides a route candidate on which communication can be continued between the starting point and the goal point based on the operation information regarding each base station that was acquired.

### TECHNICAL FIELD

The present disclosure relates to a navigation system, a route determination device, a network controller, and a navigation method for continuity of communication.

BACKGROUND

A car navigation system makes it possible to obtain route conditions that take into consideration traffic congestion conditions, time required, toll roads, the user's intentions, and the like by inputting a starting point and a goal point from a user terminal.

In addition, the prevalence of high-speed, high-capacity communication is expected to increase use of mobile communication not only for conventional uses such as viewing videos but also uses such as safe driving or remote driving.

Meanwhile, functions of base stations with low communication demand may be stopped (turned off) for purposes such as energy consumption reduction and leveling used resources. In this manner, there is a need to realize energy conservation or resource leveling for base stations while preventing the user's continuous communication use from being adversely affected.

However, technology for ensuring continuity of communication use while taking into consideration base stations whose functions have been stopped when moving along a route that was searched for by a car navigation system has hitherto not been known.

In Patent Document 1, areas where continuous communication is possible are provided by using a radio wave reception range database of reception range or strength of radio waves for communication to represent the predicted strength of radio waves by using circles centered on base stations. However, the navigation in Patent Document 1 does not ensure continuity of communication use while taking into consideration base stations whose functions have been stopped at any given time.

### CITATION LIST

### Patent Literature

Patent Document 1: JP 2006-98147 A

### SUMMARY OF INVENTION

### Technical Problem

The present disclosure has been devised to solve at least one of the shortcomings of the prior art, and a purpose thereof is to provide a navigation system, a route determination device, a network controller, and a navigation method for providing continuity of communication use during movement.

### Solution to Problem

One aspect of a navigation system according to the present disclosure is a navigation system, comprising: a route determination device that has a map information device that stores map information, and a route information providing device that selects one or more route candidates based on information indicating a starting point and a goal point in the map information; and a network controller that acquires and stores operation information regarding a base station. The network controller acquires the one or more route candidates from the route determination device and supplies, to the route determination device, operation information regarding each base station corresponding to each area on the one or more route candidates. The route information providing device at least provides a route candidate on which communication can be continued between the starting point and the goal point based on the operation information regarding each base station that was acquired.

The route determination device further has a route generation device, and the route generation device may modify the route candidate such that a portion of the route candidate where communication cannot be continued is bypassed for a portion where communication can be continued and the route information providing device may provide the modified route candidate.

The route information providing device may provide a route candidate that does not include a portion where communication cannot be continued from among multiple route candidates.

The route information providing device may provide, for each of the one or more route candidates, information indicating whether the routes are routes on which communication can be continued based on whether all the base stations are in an operating state, each base station corresponding to each area on the routes.

The navigation system further comprises a management device that generates base station information that includes the operation information regarding each of the base stations based on at least information that relates to operation of a Radio Unit (RU) of each of the base stations and a Distributed Unit (DU) communicatively connected to the RU of each of the base stations, and the network controller may acquire the base station information from the management device and store the base station information.

Acquisition of information that relates to operation of the DU and RU of each of the base stations by the management device and the acquisition of the base station information by the network controller may be performed at regular intervals, or as needed when navigation is performed.

One aspect of a route determination device according to the present disclosure is a route determination device that has a map information device that stores map information, and a route information providing device that selects one or more route candidates based on information indicating a starting point and a goal point in the map information. The route information providing device at least provides a route candidate on which communication can be continued between the starting point and the goal point based on operation information regarding each base station corresponding to each area on the one or more route candidates that was acquired from a network controller.

One aspect of a network controller according to the present disclosure is a network controller that acquires and stores operation information regarding a base station, acquires a route candidate in map information from a route determination device, and supplies, to the route determination device, operation information regarding each base station corresponding to each area on the route candidate.

One aspect of a navigation method according to the present disclosure is a navigation method, comprising:
acquiring information indicating a starting point and information indicating a goal point;
selecting one or more route candidates based on the information indicating the starting point and the information indicating the goal point in map information;
acquiring operation information regarding each base station corresponding to each area on the one or more route candidates; and
at least providing a route candidate on which communication can be continued between the starting point and the goal point based on the operation information regarding each base station that was acquired.

### Effects of Invention

According to aspects of the present disclosure, continuity of communication use can be ensured while taking into consideration base stations whose functions have been stopped when moving along a route that was searched for by a car navigation system.

### BRIEF DESCRIPTION OF DRAWINGS

FIG. 1 is a diagram illustrating an example of a route search to which a navigation system and a navigation method according to an embodiment are applied.

FIG. 2 is a schematic diagram illustrating one example of the navigation system according to an embodiment.

FIG. 3 is a schematic diagram illustrating an example of a route determination device according to an embodiment.

FIG. 4 is a schematic diagram illustrating an example of a network controller according to an embodiment.

FIG. 5 is a diagram illustrating another example of a route search to which the navigation system and the navigation method according to an embodiment are applied.

FIG. 6 is a schematic diagram for describing an operation example of the navigation system according to an embodiment.

FIG. 7 is a flow chart illustrating one example of a management method according to an embodiment.

### DESCRIPTION OF EMBODIMENTS

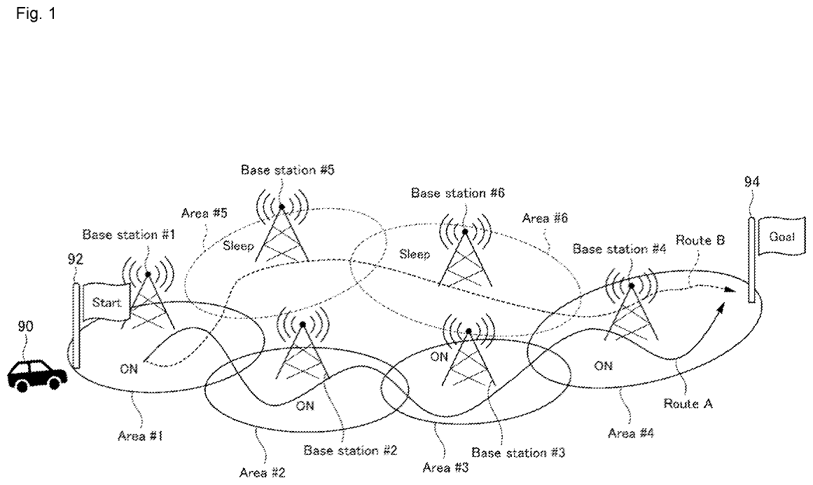

FIG. 1 is a diagram illustrating an example of a route search to which a navigation system, a route determination device, a network controller, and a navigation method according to the present embodiment are applied.

FIG. 1 illustrates six base stations, from base station #1 to base station #6. Each of the base stations in FIG. 1 comprises at least a Radio Unit (RU), as discussed below. The RU includes an antenna for transmission/reception of radio waves. Moreover, FIG. 1, in particular, schematically illustrates the locations of the RUs of base stations #1 to #6.

FIG. 1 illustrates areas #1 to #6 in which transmission/reception of radio waves to/from the antenna of the RU of each of the base stations is possible. Moreover, starting point 92 is inside area #1 and goal point 94 is inside area #4.

Route A is a route that passes sequentially through area #1, area #2, area #3, and area #4 from starting point 92 to goal point 94.

Route B is a route that passes sequentially through area #1, area #5, area #6, and area #4 from starting point 92 to goal point 94.

It is assumed that a user terminal (UE: User Equipment) moves along either of the routes as illustrated in FIG. 1. In addition, it is assumed that the user terminal will perform radio communication with the base station in each of the areas on the route while moving along the route.

The type and movement means of the user terminal is not limited. For example, FIG. 1 illustrates a vehicle 90 that can travel from starting point 92 to goal point 94, but the user terminal may be present within the vehicle 90 and the vehicle 90 itself may be a user terminal. In addition, the vehicle 90 is not essential in the present disclosure. For example, a person holding a user terminal may move by walking or the like. That is, the user terminal may be moved by a moving body and the user terminal itself may move.

In this way, the navigation system according to the present embodiment is a system for performing navigation for a user terminal using a radio network or a user or the like carrying the user terminal.

Each of the base stations as illustrated in FIG. 1 comprises at least an RU. A Distributed Unit (DU) that is communicatively connected to an RU may be provided to the same base station as the RU to which the DU is to be connected, and may also be provided at a different location than the RU to which the DU is to be connected (such as a data center). In addition, a Centralized Unit (CU) that is communicatively connected to a DU may also be provided at the same location as the DU to which the CU is to be connected, and may also be provided at a different location. Hence, from among the RU, the DU, and the CU, there may be a base station comprising only an RU, a base station comprising an RU and a DU, and a base station comprising an RU, a DU, and a CU. In addition, DUs may be virtualized DUs (vDUs) configured in virtualization infrastructure. In addition, CUs may be virtualized CUs (vCUs) configured in virtualization infrastructure. In the following descriptions, DUs and vDUs are referred to without distinction and CUs and vCUs are referred to without distinction unless otherwise required. Moreover, RUs can be switched between operating and sleeping by means of control from other devices. In addition, DUs can also be switched between operating and sleeping by means of control from other devices. Particularly in cases when DUs are vDUs, DUs can be switched between operating and sleeping by adding or deleting vDUs on virtualization infrastructure.

The switching between operating and sleeping for RUs and DUs can generally be controlled with a management device such as an Operation Support System (OSS) or an Element Management System (EMS) in a radio network system. In addition, in the present disclosure, control that relates to switching between operating and sleeping is also referred to as ON/OFF control.

In addition, in the present disclosure, when a base station can perform communication with a user terminal, the base station is referred to as being in an operating state (ON). In order for a base station to be in an operating state (ON), all three of the RU provided to the base station, the DU to which the RU connects, and the CU to which the DU connects must be ON.

In addition, in the present disclosure, the state of a base station when at least one of an RU provided to the base station and a DU to which the RU connects is OFF is referred to as a sleeping state (Sleep). Concerning vDUs in particular, the base station comprising the RU that connects to a vDU can be switched to a sleeping state by deleting the vDU on virtualization infrastructure.

For example, a base station can be switched to a sleeping state when use of the base station is low or temporarily stops for the purpose of energy conservation, leveling used resources, or the like.

As discussed previously, a user terminal will move while performing radio communication with the base station in each of the areas on a route. In FIG. 1, base station #1 is in an operating state (ON), and the user terminal can use communication (communication services) by transmitting/receiving radio waves via base station #1 in area #1.

Base stations #2 to #4 are also in an operating state similar to base station #1. In each of areas #2 to #4, the user terminal can use communication by transmitting/receiving radio waves via each of the corresponding base stations #2 to #4.

Meanwhile, if base station #5 is also in an operating state, the user terminal can use communication by transmitting/receiving radio waves via base station #5 in corresponding area #5. However, in FIG. 1, base station #5 is in a sleeping state (Sleep) in which base station #5 is not operating. Thus, even if the user terminal were to be present within area #5, the user terminal would not be able to use communication by transmitting/receiving radio waves via base station #5.

Base station #6 is also in a sleeping state similar to base station #5. Even if the user terminal were to be present within area #6, the user terminal would not be able to use communication by transmitting/receiving radio waves via base station #6.

As discussed above, route A is a route that passes sequentially through areas #1 to #4, which correspond to base stations #1 to #4 in an operating state, from starting point 92 to goal point 94. Accordingly, the user terminal can use communication from starting point 92 to goal point 94 on route A without interruption of radio waves.

In contrast, route B passes through a geographical region composed of areas #5 and #6, which correspond to base stations #5 and #6 in a sleeping state, between starting point 92 and goal point 94. Moreover, on route B, communication can be used without interruption of radio waves when passing through areas #1 and #4. However, in areas #5 and #6 (excluding the portions overlapping areas #1 and #4), base stations #5 and #6 are in a sleeping state. Thus, radio waves would be interrupted and communication could not be used.

Routes A and B are both routes from starting point 92 to goal point 94. However, continuity of communication use is ensured on route A, whereas continuity of communication use is not ensured on route B.

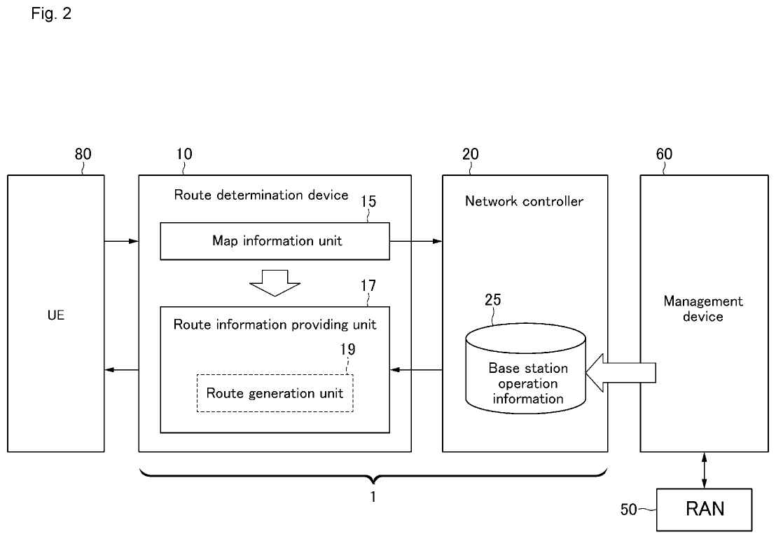

Next, the navigation system according to the present embodiment will be described with reference to FIG. 2.

FIG. 2 is a schematic diagram illustrating one example of the navigation system according to the present embodiment.

In FIG. 2, a navigation system 1 includes a route determination device 10 and a network controller 20. The navigation system 1 can further include a management device 60 communicatively connected to a radio access network (RAN) 50. The radio access network 50 is a network on the side that performs radio communication with a user terminal in a radio network, and the RUs, DUs, and CUs discussed previously are present in the radio access network 50.

The navigation system 1 acquires information indicating a starting point and information indicating a goal point from a user terminal (UE) 80. The information indicating the starting point and the information indicating the goal point are respectively information for identifying a starting point and a goal point and may, for example, be the longitude and latitude of a starting point and a goal point.

Moreover, the navigation system 1 at least provides, to the user terminal 80, a route candidate on which communication can be continued between the starting point and the goal point.

In FIG. 2, the user terminal 80 is not limited to a mobile phone terminal. For example, the user terminal 80 may be a car navigation terminal installed in the vehicle 90 in FIG. 1 or the like so long as the terminal allows a user to input information indicating a starting point and information indicating a goal point and can provide notifications regarding route information.

FIG. 2 schematically illustrates operation units of the route determination device 10 and the network controller 20.

The route determination device 10 includes a map information unit 15 and a route information providing unit 17. The route determination device 10 may optionally further include a route generation unit 19, as discussed below.

The network controller 20 includes a base station operation information storage unit 25 that stores operation information (information indicating being in an operating state or a sleeping state) regarding one or more base stations in the radio access network 50 managed by the network controller 20. The base station operation information storage unit 25 is, for example, a database.

The route determination device 10 and the network controller 20 may further include configurations that are not shown.

The map information unit 15 of the route determination device 10 stores map information and selects one or more route candidates, with reference to the map information, based on the information indicating the starting point and the information indicating the goal point that was acquired from the user terminal 80. The method for selecting route candidates is not particularly limited and a known method may be used. In particular, route candidates may be selected while taking into consideration user preferences including the user's search history, and route candidates may be generated while taking into consideration traffic conditions such as traffic congestion conditions or the weather and toll roads.

Referring to the example in FIG. 1 as well, the map information unit 15 selects one or more from among routes A and B as route candidates based on starting point 92 and goal point 94.

In particular, database-like maps called dynamic maps, in which various traffic information such as vehicle locations has been added to high-precision, three-dimensional maps, can be used as map information. Dynamic maps are suitable for selecting route candidates that incorporate traffic congestion information and the like.

The network controller 20 in FIG. 2 will be described.

The network controller 20 acquires operation information regarding one or more base stations in the radio access network 50 from the radio access network 50, and stores the operation information in the base station operation information storage unit 25.

In particular, the network controller 20 can acquire operation information regarding one or more base stations in the radio access network 50 from the management device 60 communicatively connected to the radio access network 50. The network controller 20 can acquire operation information regarding base stations from the management device 60 at regular intervals. This can be carried out by polling, Syslog, and the like.

The management device 60 queries each base station in the radio access network 50 concerning the condition of the Radio Unit (RU) connected to the Distributed Unit (DU) in particular, receives information indicating whether the RU is operating or sleeping from the DU, and stores this information as operation information regarding each of the base stations. In the present disclosure, information indicating whether RUs are operating or sleeping is also referred to as the ON/OFF condition of RUs. The management device 60 can, in particular, be an Element Management System (EMS). The management device 60 can be provided with the condition of RUs from DUs at regular intervals.

Furthermore, the network controller 20 can be a RAN Intelligent Controller (RIC), particularly a real-time RIC.

The management device 60 carries out not only navigation but also management of the base stations in the radio network system 50 in general. By storing operation information regarding base stations in the base station operation information storage unit 25 of the network controller (RIC) 20 separately from the management device (EMS) 60 for acquiring information from each of the base stations, operation information regarding base stations can be used quickly in the navigation system 1.

Moreover, the network controller 20 acquires one or more route candidates from the starting point to the goal point from the map information unit 15.

Therefore, the network controller 20 supplies, to the route information providing unit 17 of the route determination device 10, operation information regarding each base station corresponding to each area on one or more route candidates from the starting point to the goal point, that is, information indicating whether a base station is operating or sleeping.

Referring again to the example in FIG. 1 as well, the network controller 20 stores information indicating whether each of base stations #1 to #6 is in an operating state (ON) or a sleeping state (Sleep).

Moreover, the network controller 20 acquires, from the map information unit 15, one or more from among routes A and B as one or more route candidates from starting point 92 to goal point 94.

Moreover, concerning the one or more from among routes A and B from starting point 92 to goal point 94, the network controller 20 supplies, to the route information providing unit 17 of the route determination device 10, operation information regarding each base station corresponding to each area on the routes.

That is, concerning route A, the network controller 20 supplies, to the route information providing unit 17, information indicating that base stations #1 to #4 are all in an operating state. Moreover, concerning route B, the network controller 20 supplies, to the route information providing unit 17, information indicating that base stations #1, #5, #6, and #4 are respectively, in order, in an operating state, a sleeping state, a sleeping state, and an operating state.

The route information providing unit 17 of the route determination device 10 in FIG. 2 will be described further.

The route information providing unit 17 at least provides, to the user terminal 80, route candidates on which communication can be continued between a starting point and a goal point based on operation information regarding each base station in the radio access network 50.

Referring again to the example in FIG. 1 as well, the route information providing unit 17 may provide, to the user terminal 80, information indicating that communication can be continued on route A from starting point 92 to goal point 94.

The configurations of the route determination device 10 and the network controller 20 will be described first, with the providing of route candidates to the user terminal 80 to be discussed below.

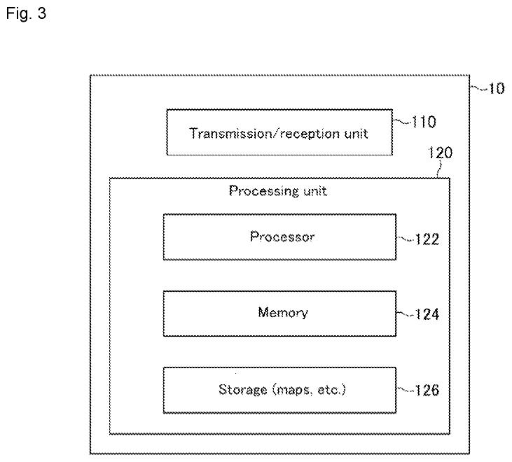

FIG. 3 is a schematic diagram illustrating an example of the route determination device 10 according to an embodiment. The route determination device 10 includes a transmission/reception unit 110 and a processing unit 120.

The transmission/reception unit 110 performs transmission/reception of data between the user terminal 80 and the network controller 20 in FIG. 2.

The processing unit 120 includes a processor 122 and a memory 124. There may be one or more processors 122 and memories 124. The processing unit 120 may further include storage 126. The processing unit 120 causes the transmission/reception unit 110 to operate and can, by means of the processor 122 and the memory 124, execute data processing as the map information unit 15, the route information providing unit 17, and optionally the route generation unit 19 in FIG. 2.

Furthermore, the storage 126 can store map information. In particular, the storage 126 can store dynamic maps as map information.

The route determination device 10 may further include configurations that are not illustrated in FIG. 3.

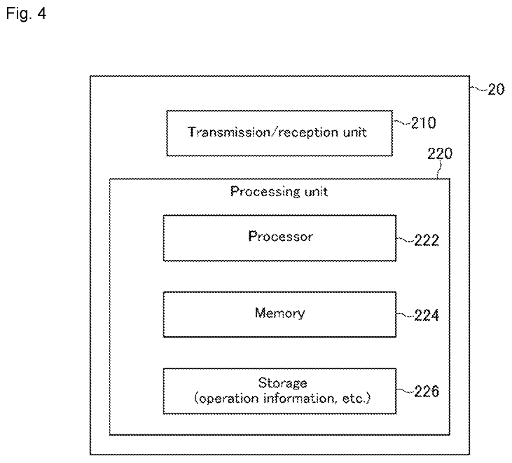

FIG. 4 is a schematic diagram illustrating an example of the network controller 20 according to an embodiment. The network controller 20 includes a transmission/reception unit 210 and a processing unit 220.

The transmission/reception unit 210 performs transmission/reception of data between the route determination device 10 and the management device 60 illustrated in FIG. 2.

The processing unit 220 includes a processor 222 and a memory 224. There may be one or more processors 222 and memories 224. The processing unit 220 may further include storage 226. The processing unit 220 causes the transmission/reception unit 210 to operate and can, by means of the processor 222 and the memory 224, execute data processing as the network controller 20.

Furthermore, the storage 226 can store operation information regarding base stations.

The network controller 20 may further include configurations that are not illustrated in FIG. 4.

In addition, for example, the route determination device 10 and the network controller 20 may coexist in one device and share at least one of a transmission/reception unit, a processor, a memory, and storage.

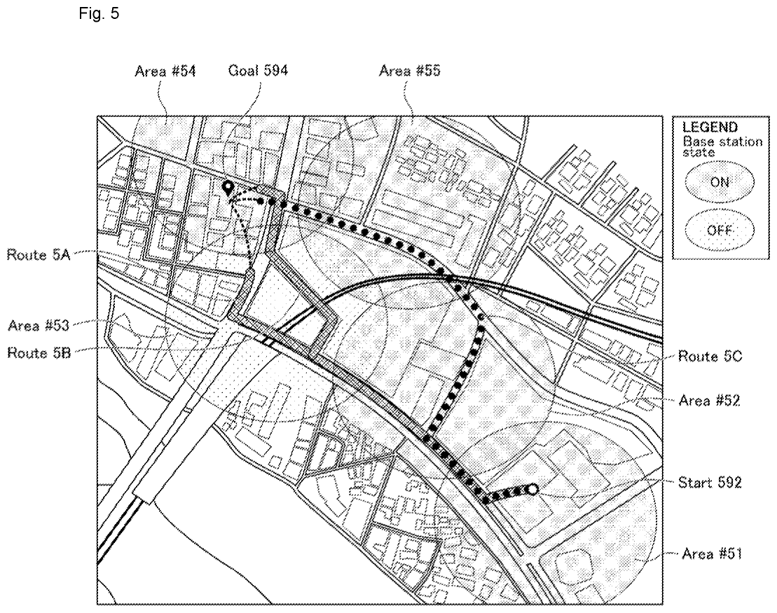

Returning to FIG. 2, concerning the route information providing unit 17 of the route determination device 10, an example in which a route candidate on which communication can be continued is provided to the user terminal 80 will be described with reference to the example in FIG. 5.

FIG. 5 is a diagram illustrating another example of a route search to which the navigation system and a navigation method according to the present embodiment are applied.

In FIG. 5, three route candidates (route 5A, route 5B, and route 5C) from starting point 592 to goal point 594 are illustrated. Furthermore, there are five areas from area #51 to area #55.

Moreover, because the base stations corresponding to four of the areas, area #51, area #52, area #54, and area #55, are in an operating state (ON), radio communication by a UE is possible inside these areas. In contrast, because the base station corresponding to area #53 is in a sleeping state (Sleep), radio communication by a UE is not possible within area #53 (excluding the portions overlapping areas #52, #54, and #55).

With the foregoing in mind, three typical examples in which a route candidate on which communication can be continued is provided to the user terminal 80 will be described. The provision of a route candidate on which communication can be continued to the user terminal 80 is not limited to these three examples.

### EXAMPLE 1

In FIG. 2, the route determination device 10 can further include a route generation unit 19. The route generation unit 19 modifies a route candidate such that a portion of the route candidate where communication cannot be continued is bypassed for a portion where communication can be continued, and the route information providing unit 17 provides the modified route candidate to the user terminal 80.

This makes it possible for only a modified route candidate to be displayed on a display unit of the user terminal 80 without a yet-to-be-corrected route candidate that includes a portion where communication cannot be continued being displayed.

Referring to the example in FIG. 5 as well in addition to FIG. 2, assume that route 5A from starting point 592 to goal point 594 is selected as a route candidate by the map information unit 15 on the basis of, for example, user preferences or traffic conditions and the like.

Route 5A passes through area #53 as a portion where communication cannot be continued. As such, for route 5A, the route generation unit 19 modifies the route candidate such that the portion of route 5A that passes through area #53 is bypassed for portions where communication can be continued (areas #51, #52, #54, and #55).

For example, a new route candidate may be generated by searching for a route from the starting point to the goal point again under the condition that the user terminal cannot enter area #53, and route 5A may be replaced with the new route candidate.

Alternatively, the point on route 5A where communication on the route candidate switches from available to unavailable may be regarded as a second starting point, route candidates from the second starting point to the goal point may be generated as bypass route candidates, and from among the bypass route candidates that were generated, the bypass route candidate on which communication can be continued may be determined as a bypass route. Then, the route on route 5A from the second starting point to the goal point may be replaced with the bypass route.

Alternatively, for example, the point on route 5A where communication switches from unavailable to available may be regarded as a second goal point, route candidates from the second starting point to the second goal point may be generated as bypass route candidates, and from among the bypass route candidates that were generated, the bypass route candidate on which communication can be continued may be determined as a bypass route. Then, the portion on route 5A from the second starting point to the second goal point may be replaced with the bypass route to thereby modify the route candidate.

In the example in FIG. 5, route 5A has been modified to route 5C, and the route information providing unit 17 provides route 5C to the user terminal 80.

When route 5B from starting point 592 to goal point 594 is selected as a route candidate by the map information unit 15 as well, route 5B passes through area #53 as a portion where communication cannot be continued. Accordingly, route 5B is modified by the route generation unit 19. In the example in FIG. 5, route 5B has also been modified to route 5C.

This makes it possible for only route 5C to be displayed on the display unit of the user terminal 80. Yet-to-be-corrected routes 5A and 5B are not displayed.

### EXAMPLE 2

In FIG. 2, the route information providing unit 17 provides a route candidate that does not include a portion where communication cannot be continued from among multiple route candidates.

This makes it possible for only a route candidate that does not include a portion where communication cannot be continued to be displayed on the display unit of the user terminal 80 without a route candidate that includes a portion where communication cannot be continued being displayed.

Referring to the example in FIG. 5 as well in addition to FIG. 2, assume that routes 5A, 5B, and 5C from starting point 592 to goal point 594 are selected by the map information unit 15 as three route candidates.

Route 5C does not pass through any areas where communication cannot be continued. Routes 5A and 5B pass through area #3 as a portion where communication cannot be continued.

Accordingly, in the example in FIG. 5, the route information providing unit 17 provides, to the user terminal 80, route 5C that does not include a portion where communication cannot be continued from among routes 5A, 5B, and 5C.

This makes it possible for only route 5C to be displayed on the display unit of the user terminal 80. Routes 5A and 5B are not displayed.

### EXAMPLE 3

In FIG. 2, the route information providing unit 17 provides, for each of one or more route candidates, information indicating whether the routes are routes on which communication can be continued based on whether all the base stations are in an operating state, each base station corresponding to each area on the routes.

This makes it possible for route candidates to be displayed so as to be distinguished between those on which communication continuity is possible and those on which communication continuity is not possible by displaying the route candidates, for example, in different colors, with annotations added thereto, or the like on the display unit of the user terminal 80.

Referring to the example in FIG. 5 as well in addition to FIG. 2, assume that routes 5A, 5B, and 5C from starting point 592 to goal point 594 are selected by the map information unit 15 as three route candidates.

On route 5C, communication with the base stations that are operating can be continued. Because routes 5A and 5B pass through area #3 as a portion where communication cannot be continued, communication with the base stations that are operating cannot be continued thereon.

Consequently, the route information providing unit 17 provides, to the user terminal 80, information indicating that communication continuity is possible on route 5C and communication continuity is not possible on routes 5A and 5B.

This makes it possible to display route 5C on which communication continuity is possible and routes 5A and 5B on which communication continuity is not possible in different colors on the display unit of the user terminal 80. Additionally, route 5C can be displayed by adding an annotation indicating that communication continuity is possible thereon, and routes 5A and 5B can be displayed by adding an annotation indicating that communication continuity is not possible thereon.

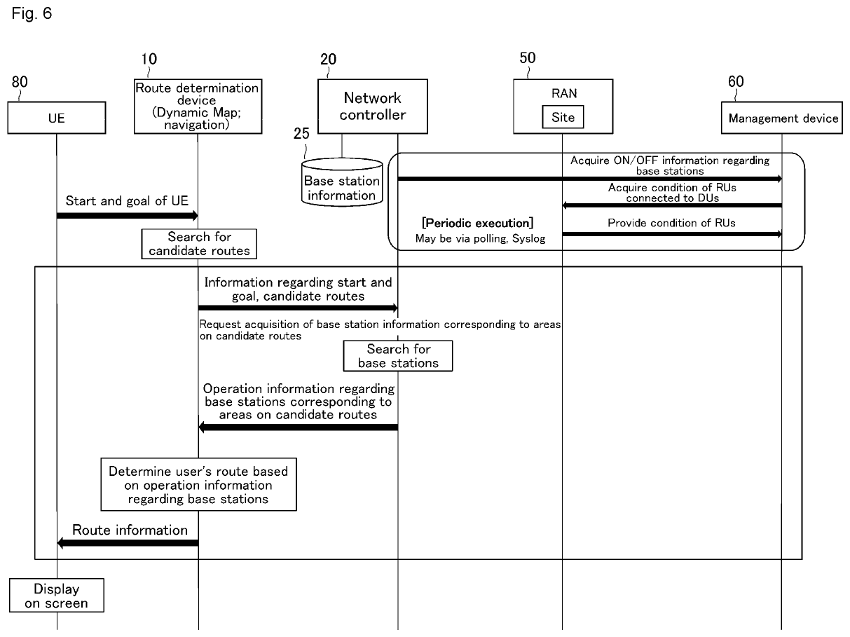

FIG. 6 is a schematic diagram for describing an operation example of the navigation system according to an embodiment.

The management device 60 queries a DU in the radio access network 50. The management device 60 is provided with information, from the DU, indicating an ON/OFF condition of the DU and an RU that connects to the DU. In this manner, the management device 60 stores operation information (whether a base station is operating or sleeping) regarding one or more base stations in the radio access network 50. In particular, the management device 60 acquires and stores operation information regarding one or more base stations at regular intervals. The management device 60 is, in particular, an EMS.

The network controller 20 acquires, from the management device 60, operation information concerning one or more base stations in the radio access network 50 at regular intervals, independent of execution of navigation, by polling, Syslog, or the like. This makes it possible for the operation information regarding base stations to be constantly updated. Moreover, the accuracy of the provision of candidate routes on which communication can be continued can be increased by using the latest operation information regarding base stations when executing navigation.

Alternatively, the acquisition of operation information regarding base stations by the management device 60 and the acquisition of operation information regarding base stations from the management device 60 by the network controller 20 can be carried out as needed when navigation is performed. This makes it possible to acquire operation information regarding base stations in a timely manner during navigation.

In addition, the network controller 20 is particularly a (real-time) RIC.

The network controller 20 stores operation information concerning one or more base stations that was acquired from the management device 60 in the base station operation information storage unit 25.

By storing operation information concerning one or more base stations in the network controller 20, operation information regarding base stations can be used quickly in navigation.

The route determination device 10 searches for candidate routes in map information based on information indicating the starting point and information indicating the goal point acquired from the user terminal (UE) 80. In particular, dynamic maps can be used as map information.

The route determination device 10 supplies, to the network controller 20, information regarding candidate routes that includes the information indicating the starting point and the information indicating the goal point, and requests acquisition of operation information regarding each base station corresponding to each area on the candidate routes.

The network controller 20 provides, to the route determination device 10, operation information regarding each base station corresponding to each area on the candidate routes.

The route determination device 10 determines the user's route based on operation information regarding each base station, and supplies the route to the user terminal 80 as route information.

The user terminal 80 displays the route information on, for example, a screen thereof.

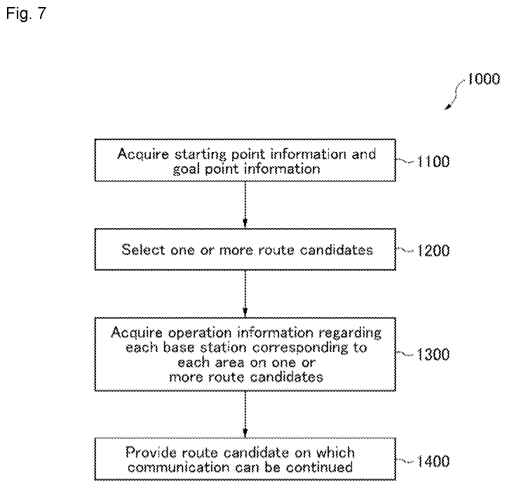

FIG. 7 is a flow chart illustrating one example of a management method according to the present embodiment. This management method can be processed by, for example, the route determination device illustrated in FIG. 3.

In a management method 1000, information indicating a starting point and information indicating a goal point are acquired from a user terminal (1100 in FIG. 7).

Next, one or more route candidates are selected based on the information indicating the starting point and the information indicating the goal point that were acquired (1200 in FIG. 7).

Next, operation information regarding each base station corresponding to each area on the one or more route candidates that were selected is acquired (1300 in FIG. 7).

Then, a route candidate on which communication can be continued is recognized and provided to a user terminal based on the operation information regarding each base station that was acquired (1400 in FIG. 7).

A program for making one or more processors execute the navigation method discussed above is also further included in the present disclosure. The program may be provided by being recorded on a computer-readable, non-transitory storage medium.

The program may be stored in a volatile or non-volatile memory 124 in the processing unit 120 of the route determination device 10 in FIG. 3 to make the one or more processors 122 operate.

The program may be stored in a volatile or non-volatile memory 224 in the processing unit 220 of the network controller 20 in FIG. 4 to make the one or more processors 222 operate.

The present disclosure is not limited to the embodiments discussed above and includes various modified examples in which constituent elements have been added, removed, or replaced with respect to the configurations discussed above. In addition, the examples can be combined in various ways.

The term “connect” used in the present descriptions means a logical connection for communication. For example, “an RU connected to a DU” means the DU and the RU are logically connected such that communication therebetween is possible. There is no need for the DU and the RU to be directly connected physically by a physical cable or the like. Multiple apparatuses or radio communications may also be interposed between the DU and the RU.

### REFERENCE SIGNS LIST

1 Navigation system

10 Route determination device

15 Map information unit

17 Route information providing unit

19 Route generation unit

20 Network controller

25 Base station operation information storage unit (database)

50 Radio access network (RAN)

60 Management device

80 User terminal (UE)

90 Vehicle

92, 592 Starting point

94, 594 Goal point

110, 210 Transmission/reception unit

120, 220 Processing unit

122, 222 Processor

124, 224 Memory

126, 226 Storage

1. A navigation system, comprising:
a route determination device that has a map information device that stores map information and a route information providing device that selects at least one route candidate based on information indicating a starting point and a goal point in the map information; and
a network controller that acquires and stores operation information regarding a base station,
wherein the network controller acquires the one or more route candidates from the route determination device and supplies, to the route determination device, operation information regarding each base station corresponding to each area on the one or more route candidates, and
the route information providing device at least provides a route candidate on which communication can be continued between the starting point and the goal point based on the operation information regarding each base station that was acquired.

2. The navigation system according to claim 1,
wherein the route determination device further has a route generation device, and
the route generation device modifies the route candidate such that a portion of the route candidate where communication cannot be continued is bypassed for a portion where communication can be continued and the route information providing device provides the modified route candidate.

3. The navigation system according to claim 1, wherein the route information providing device provides a route candidate that does not include a portion where communication cannot be continued from among multiple route candidates.

4. The navigation system according to claim 1, wherein the route information providing device provides, for each of the one or more route candidates, information indicating whether the routes are routes on which communication can be continued based on whether all the base stations are in an operating state, each base station corresponding to each area on the routes.

5. The navigation system according to claim 1, further comprising:
a management device that generates base station information that includes the operation information regarding each of the base stations based on at least information that relates to operation of a Radio Unit (RU) and a Distributed Unit (DU) communicatively connected to the RU of each of the base stations,
wherein the network controller acquires the base station information from the management device and stores the base station information.

6. The navigation system according to claim 5, wherein acquisition of information that relates to operation of the DU and RU of each of the base stations by the management device and the acquisition of the base station information by the network controller are performed at regular intervals, or as needed when navigation is performed.

7. A route determination device that has a map information device that stores map information and a route information providing device that selects one or more route candidates based on information indicating a starting point and a goal point in the map information,
wherein the route information providing device at least provides a route candidate on which communication can be continued between the starting point and the goal point based on operation information regarding each base station corresponding to each area on the one or more route candidates that was acquired from a network controller.

8. A network controller that acquires and stores operation information regarding a base station,
wherein the network controller acquires a route candidate in map information from a route determination device and supplies, to the route determination device, operation information regarding each base station corresponding to each area on the route candidate.

9. A navigation method, comprising:
acquiring information indicating a starting point and information indicating a goal point;
selecting one or more route candidates based on the information indicating the starting point and the information indicating the goal point in map information;
acquiring operation information regarding each base station corresponding to each area on the one or more route candidates; and
at least providing a route candidate on which communication can be continued between the starting point and the goal point based on the operation information regarding each base station that was acquired.
